(19) United States
(12) Patent Application Publication
(10) Pub. No.: US 2021/0158424 A1
(43) Pub. Date: May 27, 2021

(54) TECHNIQUES FOR IMPROVING PRODUCT RECOMMENDATIONS USING PERSONALITY TRAITS

(71) Applicant: L'Oreal, Paris (FR)

(72) Inventor: Caroline Renard, Paris (FR)

(73) Assignee: L'Oreal, Paris (FR)

(21) Appl. No.: 16/697,588

(22) Filed: Nov. 27, 2019

(51) Int. Cl. G06Q 30/06

(52) U.S. Cl. CPC G06Q 30/0631; G06Q 30/0641

(57) ABSTRACT

In some embodiments, a computer-implemented method of generating and providing product recommendations is provided. A computing device determines at least one color associated with a subject. The computing device determines at least one personality trait of the subject. The computing device determines at least one product recommendation based on at least the at least one color and the at least one personality trait. The at least one product recommendation is provided to the subject. In some embodiments, a beauty identity card is provided that includes information collected by or determined by the computing device.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of generating and providing product recommendations to a subject is provided. A computing device determines at least one color associated with the subject. The computing device determines at least one personality trait of the subject. The computing device determines at least one product recommendation based on at least the at least one color and the at least one personality trait. The at least one product recommendation is provided to the subject.

In some embodiments, a computing device is provided. The computing device is configured to determine at least one color associated with a subject; determine at least one personality trait of the subject; determine at least one product recommendation based on at least the at least one color and the at least one personality trait; and provide the at least one product recommendation to the subject.

In some embodiments, a system is provided. The system comprises a color detection engine, a questionnaire analysis engine, and a recommendation engine. The color detection engine includes computational circuitry configured to determine at least one color associated with a subject. The questionnaire analysis engine includes computational circuitry configured to determine at least one personality trait of the subject. The recommendation engine includes computational circuitry configured to determine at least one product recommendation based on at least the at least one color and the at least one personality trait, and to provide the at least one product recommendation to the subject.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates a non-limiting example embodiment of a system for generating and providing product recommendations to a subject according to various aspects of the present disclosure;

FIG. 2 is a block diagram that illustrates a non-limiting example embodiment of a system that includes a mobile computing device and a server computing device according to various aspects of the present disclosure;

FIG. 3 is a flowchart that illustrates a non-limiting example embodiment of a method of generating and providing product recommendations to a subject according to various aspects of the present disclosure;

FIG. 4 is a block diagram that illustrates a non-limiting example embodiment of a computing device appropriate for use as a computing device with embodiments of the present disclosure.

### DETAILED DESCRIPTION

In order to produce recommendations for beauty products, most existing techniques merely attempt to directly discern a subject's product preferences. Some techniques may attempt to determine a subject's product preferences based on the subject's stated preferences for colors, finishes, or products. Some other techniques may attempt to determine a subject's product preferences based on stated preferences for colors, or based on matching product colors to selected colors provided by the subject.

However, these techniques produce sub-optimal recommendations, at least because only explicitly stated subject preferences are taken into account. Even in the presence of explicitly stated subject preferences, other factors (including but not limited to personality traits) In order to produce recommendations for beauty products, most existing techniques merely attempt to directly discern a subject's product preferences. Some techniques may attempt to determine a subject's product preferences based on the subject's stated preferences for colors, finishes, or products. Some other techniques may attempt to determine a subject's product preferences based on stated preferences for colors, or based on matching product colors to selected colors provided by the subject.

However, these techniques produce sub-optimal recommendations, at least because only explicitly stated subject preferences are taken into account. Even in the presence of explicitly stated subject preferences, other factors (including but not limited to personality traits) may also influence what products a given subject will prefer. Accordingly, in some embodiments of the present disclosure, personality traits of the subject are taken into account (along with other factors) while generating product preferences for a subject. Further, in order to most effectively communicate the product recommendation to the subject, in some embodiments a beauty identity card may be generated that lists the determined personality traits and other identified characteristics of the subject and/or the recommended products that led to the recommendation.

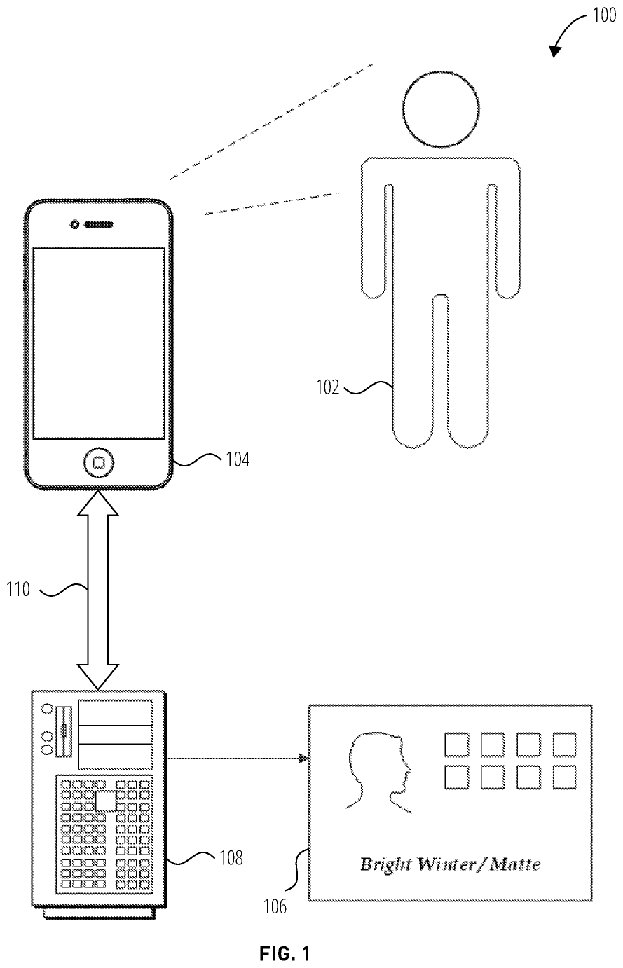

FIG. 1 is a schematic diagram that illustrates a non-limiting example embodiment of a system for generating and providing product recommendations to a subject according to various aspects of the present disclosure. In the system 100, a subject 102 interacts with a mobile computing device 104. In some embodiments, the mobile computing device 104 may be used to capture an image of the subject 102, from which at least one color, including but not limited to a hair color, an iris color, or a skin color (such as a skin intensity, undertone, and/or chroma) may be extracted. In some embodiments, the mobile computing device 104 may also be used to present a questionnaire to the subject 102. The questionnaire may include questions that allow preferences for the subject 102 to be determined, and may also allow at least one personality trait to be determined. The image and the responses to the questionnaire may be transmitted to a server computing system 108. The server computing system 108 may then extract the at least one color and determine the preferences (such as one or more textures, one or more finishes, one or more galenics, and one or more make-up and/or hair styles) and the at least one personality trait, and use this information to generate at least one product recommendation. The at least one product recommendation, as well as other information about the subject 102, may be provided to the subject 102 via a beauty identity card 106 to provide a convenient, simple format for reviewing the information.

As shown, the mobile computing device 104 and the server computing system 108 may communicate via a network 110. The network 110 may include any suitable networking technology, including but not limited to a wireless communication technology (including but not limited to Wi-Fi, WiMAX, Bluetooth, 2G, 3G, 4G, 5G, and LTE), a wired communication technology (including but not limited to Ethernet, USB, and FireWire), or combinations thereof.

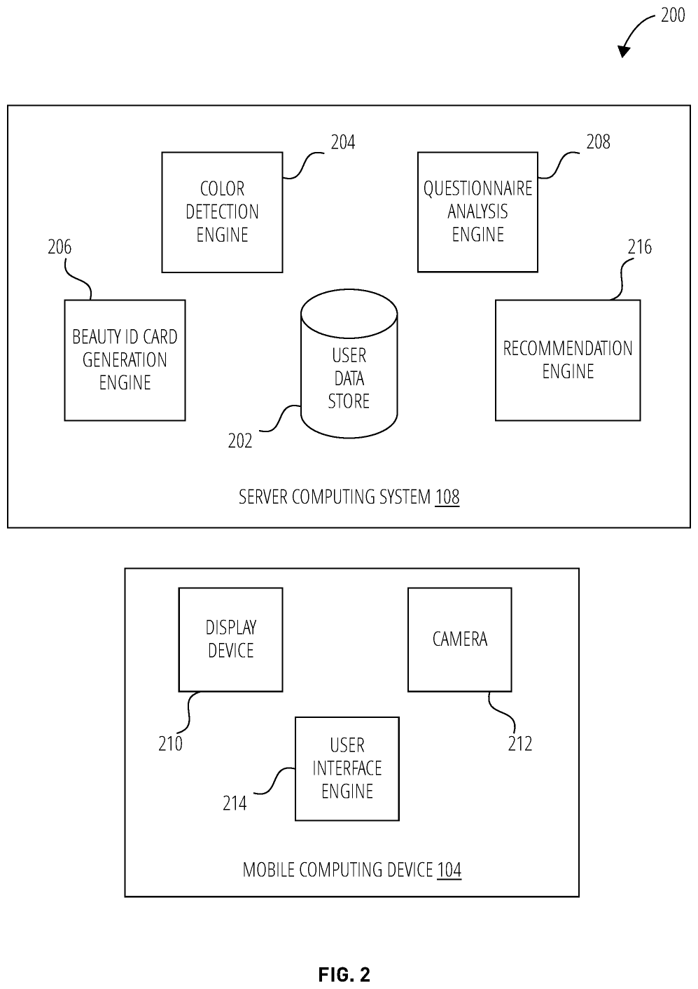

FIG. 2 is a block diagram that illustrates a non-limiting example embodiment of a system that includes a mobile computing device and a server computing device according to various aspects of the present disclosure. As shown, the system 200 comprises a mobile computing device 104 and a server computing system 108.

In some embodiments, the mobile computing device 104 may be a smartphone. In some embodiments, the mobile computing device 104 may be any other type of computing device having the illustrated components, including but not limited to a tablet computing device or a laptop computing device. In some embodiments, the mobile computing device 104 may not be mobile, but may instead by a stationary computing device such as a desktop computing device. In some embodiments, the illustrated components of the mobile computing device 104 may be within a single housing. In some embodiments, the illustrated components of the mobile computing device 104 may be in separate housings that are communicatively coupled through wired or wireless connections (such as a laptop computing device with an external camera connected via a USB cable). The mobile computing device 104 also includes other components that are not illustrated, including but not limited to one or more processors, a non-transitory computer-readable medium, a power source, and one or more communication interfaces.

As shown, the mobile computing device includes a display device 210, a camera 212, and a user interface engine 214.

In some embodiments, the display device 210 is an LED display, an OLED display, or another type of display for presenting a user interface. In some embodiments, the display device 210 may be combined with or include a touch-sensitive layer, such that a subject 102 may interact with a user interface presented on the display device 210 by touching the display. In some embodiments, a separate user interface device, including but not limited to a mouse, a keyboard, or a stylus, may be used to interact with a user interface presented on the display device 210.

In some embodiments, the user interface engine 214 is configured to present a user interface on the display device 210, including presenting at least one questionnaire for collecting information from the subject 102. In some embodiments, the user interface engine 214 may be configured to use the camera 212 to capture images of the subject 102 in order to determine at least one color associated with the subject 102.

In some embodiments, the camera 212 is any suitable type of digital camera that is used by the mobile computing device 104. In some embodiments, the mobile computing device 104 may include more than one camera 212, such as a front-facing camera and a rear-facing camera.

In some embodiments, the server computing system 108 includes one or more computing devices that each include one or more processors, non-transitory computer-readable media, and network communication interfaces that are collectively configured to provide the components illustrated below. In some embodiments, the one or more computing devices that make up the server computing system 108 may be rack-mount computing devices, desktop computing devices, or computing devices of a cloud computing service.

As shown, the server computing system 108 includes a user data store 202, a color detection engine 204, a beauty ID card generation engine 206, a questionnaire analysis engine 208, and a recommendation engine 216.

In some embodiments, the user data store 202 is configured to store records for each subject 102 that uses the system 200. The records may include at least one color, at least one texture, at least one finish, at least one galenic, at least one make-up and/or hair style, at least one image, responses to a questionnaire, at least one personality trait, at least one product recommendation, and/or other information collected or determined by the system 200.

In some embodiments, the color detection engine 204 may be configured to process an image captured of the subject 102 in order to determine at least one color associated with the subject 102, such as a skin color (e.g., a skin tone or an undertone), a hair color, or an iris color. In some embodiments, the questionnaire analysis engine 208 may be configured to receive responses to a questionnaire from the subject 102, and may determine at least one personality trait of the subject 102 based on the responses. In some embodiments, the recommendation engine 216 may be configured to generate at least one product recommendation for the subject 102 based at least on the at least one color and the at least one personality trait. In some embodiments, the beauty ID card generation engine 206 may be configured to generate a beauty identity card for the subject 102 based on the information gathered and determined by the server computing system 108.

Further details about the actions performed by each of these components are provided below.

“Engine” refers to refers to logic embodied in hardware or software instructions, which can be written in a programming language, such as C, C++, COBOL, JAVA™, PHP, Perl, HTML, CSS, JavaScript, VBScript, ASPX, Microsoft .NET™, Go, and/or the like. An engine may be compiled into executable programs or written in interpreted programming languages. Software engines may be callable from other engines or from themselves. Generally, the engines described herein refer to logical modules that can be merged with other engines, or can be divided into sub-engines. The engines can be stored in any type of computer-readable medium or computer storage device and be stored on and executed by one or more general purpose computers, thus creating a special purpose computer configured to provide the engine or the functionality thereof.

“Data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

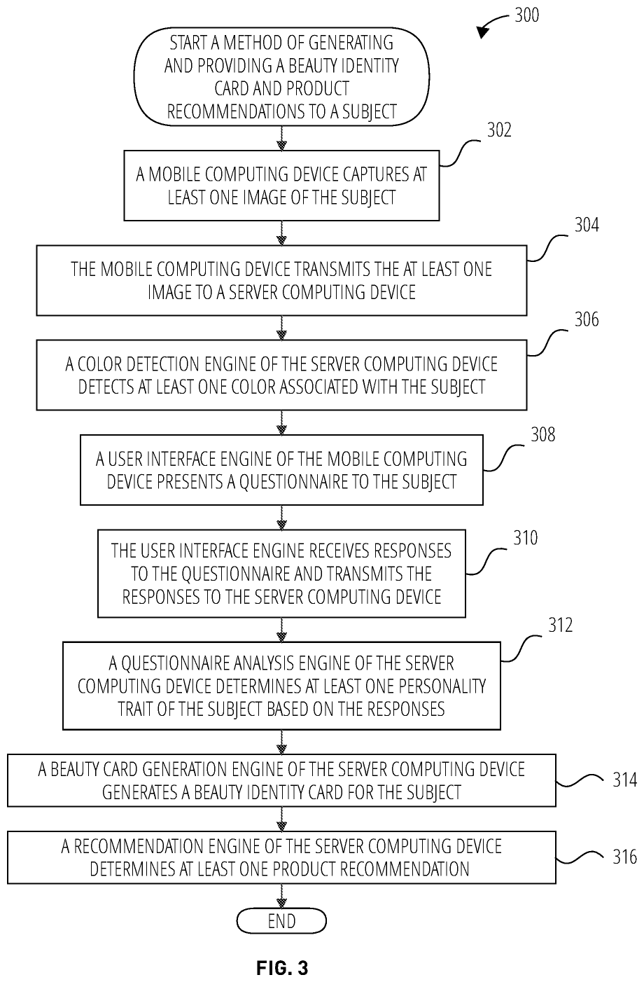

FIG. 3 is a flowchart that illustrates a non-limiting example embodiment of a method of generating and providing a beauty identity card and product recommendations to a subject according to various aspects of the present disclosure. From a start block, the method 300 proceeds to block 302, where a mobile computing device 104 captures at least one image of the subject 102. In some embodiments, the mobile computing device 104 uses the camera 212 to capture the at least one image. In some embodiments, more than one image with different lighting conditions may be captured in order to allow an accurate color determination to be generated. In some embodiments, the captured image may include a color reference such as a color card, a white balance card, or another reference in order to allow an accurate color determination to be generated.

At block 304, the mobile computing device 104 transmits the at least one image to a server computing system 108. As illustrated in FIG. 1, the mobile computing device 104 may transmit the at least one image to the server computing system 108 via the network 110. Once received, the at least one image may be stored in the user data store 202.

At block 306, a color detection engine 204 of the server computing system 108 detects at least one color associated with the subject 102. In some embodiments, the color detection engine 204 may use computer vision techniques, including but not limited to a convolutional neural network, in order to detect relevant portions of the image, including but not limited to hair, eyes, and skin areas. The color detection engine 204 may then determine a hair color, an iris color, and/or a skin color based on the relevant portions of the image. In some embodiments, the color detection engine 204 may also detect a color reference (such as a color card) within the image, and may use the color reference in order to correct the detected colors. The determined at least one color may be stored in the user data store 202.

In some embodiments, instead of transmitting the image to the server computing system 108 for color detection, the color detection engine 204 may be present on the mobile computing device 104, and the mobile computing device 104 may transmit the detected at least one color to the server computing system 108 instead of the image itself. In some embodiments, the color may be received by the mobile computing device 104 or the server computing system 108 from another device, including but not limited to a colorimeter such as a ShadeFinder device provided by Lancôme. For example, a skin color may be determined by the colorimeter, and the determined skin color may be transmitted by the colorimeter to the mobile computing device 104 or the server computing system 108. In some embodiments, non-color information, including but not limited to a face shape, a product texture, a product finish, a product galenic, a make-up style, and/or a hair style may also be determined from the image by either the mobile computing device 104 or the server computing system 108.

At block 308, a user interface engine 214 of the mobile computing device 104 presents a questionnaire to the subject 102. In some embodiments, the questionnaire may include questions that directly represent values for the subject 102. For example, the questionnaire may expressly ask the subject 102 to input a hair color, an iris color, a skin type, and/or a hair type (e.g., straight/wavy/curly, thick/thin, etc.). As another example, the questionnaire may expressly ask the subject 102 for preferred colors, preferred clothing styles, preferred textures, preferred finishes, preferred galenics, preferred make-up styles, preferred hair styles, or existing product preferences.

In some embodiments, the questionnaire may also include questions suitable for determining at least one personality trait of the user. For example, questions for determining a Myers-Briggs personality type, or Myers-Briggs Type Indicator (MBTI), may be included within the questionnaire. Any suitable format for the MBTI questions may be used, including but not limited to the roughly 93 forced-choice questions of the MBTI Step I test. As another example, questions for determining an Enneagram of Personality for the subject may be included within the questionnaire In some embodiments, other personality traits may be determined. For example, responses to the questionnaire may be usable to determine an elemental type associated with the subject 102, such as one of air, fire, earth, and water, that indicate various levels of emotional, intellectual, structural, and impulse-related centeredness.

At block 310, the user interface engine 214 receives responses to the questionnaire and transmits the responses to the server computing system 108. The user interface engine 214 may receive the responses via input into the user interface presented on the display device 210. Once received by the server computing system 108, the responses may be stored in the user data store 202.

At block 312, a questionnaire analysis engine 208 of the server computing system 108 determines at least one personality trait of the subject based on the responses. The determined at leas tone at least one personality trait may be stored in the user data store 202. In some embodiments, the questionnaire analysis engine 208 may directly process the responses to determine at least one personality trait, such as a Myers-Briggs personality type. In some embodiments, the questionnaire analysis engine 208 may transmit the responses to another system for processing, and may receive a result that indicates the at least one personality trait.

In some embodiments, the questionnaire analysis engine 208 may determine a personality trait based on the responses, and may then validate the personality trait using a separate technique. For example, an elemental type can be validated based on feedback from the subject 102 collected in response to feeling fabrics of various textures that are known to be correlated to elemental types. The questionnaire analysis engine 208 may cause a sample pack to be generated that includes the fabrics to be sampled to be sent to the subject 102, and the subject 102 may provide feedback regarding the fabrics to the questionnaire analysis engine 208 via the mobile computing device 104.

At block 314, a beauty ID card generation engine 206 of the server computing system 108 generates a beauty identification card 106 for the subject 102. In some embodiments, generating the beauty identity card 106 may include creating an image or other data suitable for display on the display device 210 of the mobile computing device 104. In some embodiments, generating the beauty identity card 106 may include printing information on paper, cardstock, or another suitable medium, and delivering the printed card to the subject 102.

In some embodiments, the beauty identity card 106 includes at least one image of the subject 102 and other information regarding the subject 102 gathered or determined by the server computing system 108. For example, the beauty identity card 106 may include a palette illustrating recommended shades of products determined by the recommendation engine 216 for the subject 102. In some embodiments, the beauty identity card 106 may include characteristics of specific recommended products (such as a brand, sub-brand, a color, a smell, a texture, and/or a function), such that the subject 102 could refer to the beauty identity card 106 to find other products with similar characteristics.

The beauty identity card 106 may also include an indication of the at least one personality trait determined by the server computing system 108, the determined skin color, and/or information gathered by the questionnaire (such as the hair color/type, the skin type, and a hair and/or makeup style). As a non-limiting example, the beauty identity card 106 may list the color territory for the subject 102 (e.g., true spring, bright winter, dark summer, etc.), a texture, a finish, a galenic, a Myers-Briggs personality type (e.g., INTJ), and/or an Enneagram of Personality type.

The subject 102 may then use the beauty identity card 106 as a reference for both products and/or personality types when shopping for other products. In some embodiments, wherein the method 300 is guided by a beauty advisor at a physical location, presentation of the beauty identity card 106 may also include draping example fabrics with recommended textures and colors, and/or applying recommended make-up products as a demonstration.

At block 316, a recommendation engine 216 of the server computing system 108 determines at least one product recommendation. In some embodiments, the at least one product recommendation may be based directly on at least the at least one color and the at least one personality trait determined by the color detection engine 204 and questionnaire analysis engine 208. In some embodiments, the at least one product recommendation may also be based on one or more of a texture, a finish, a galenic, a make-up style, and/or a hair style. In some embodiments, the beauty identity card 106 may be used by the recommendation engine 216 to determine the at least one product recommendation.

In some embodiments, the recommendation engine 216 may determine a color territory for the subject 102 (e.g., winter/spring/summer/fall) based on the at least one color determined by the color detection engine 204. In some embodiments, the recommendation engine 216 may further refine the color territory with a true/bright/dark/light/soft/etc. parameter that changes one or more of an intensity, an undertone, and a chroma of the color territory colors. In some embodiments, the parameter may be determined based on the at least one personality trait, the at least one color, and/or other information. For example, if the subject 102 was determined to be a winter based on a skin tone and an undertone, the recommendation engine 216 may further determine that the subject 102 is a bright winter based on an Extroverted Myers-Briggs personality type.

In some embodiments, the at least one personality trait may not be used to determine the palette, but may instead be used to determine a recommendation of a texture, make-up style, or hair style. For the make-up style, this may be a combination of the at least one personality trait and the face shape. The make-up style may also be adapted to various occasions and/or moment of life (for example, week-end styles versus work styles). In some embodiments, the at least one product recommendation may be based solely on the at least one color.

The recommendation engine 216 may then determine one or more products associated with the color territory and the at least one personality trait, and may use the determined one or more products as the product recommendations. The recommendation engine 216 may use preferences and/or feedback provided by other users with similar seasonal palettes and/or personality traits to determine the associated products. In some embodiments, the recommendation engine 216 may also use combinations of features, such as a combination of color and texture (for make-up products), or texture and skin type (for skin care products), and/or hair color territory, hair type, and needs (for hair color products). The determined one or more products may be stored in the user data store 202. In some embodiments, the at least one product recommendation may be provided to the subject 102 via any suitable means, including but not limited to a message (including but not limited to an e-mail, an SMS message, a message on a social media platform, or a message on a web site), a direct mailing, or a verbal recommendation provided by a salesperson.

The method 300 then proceeds to an end block and terminates.

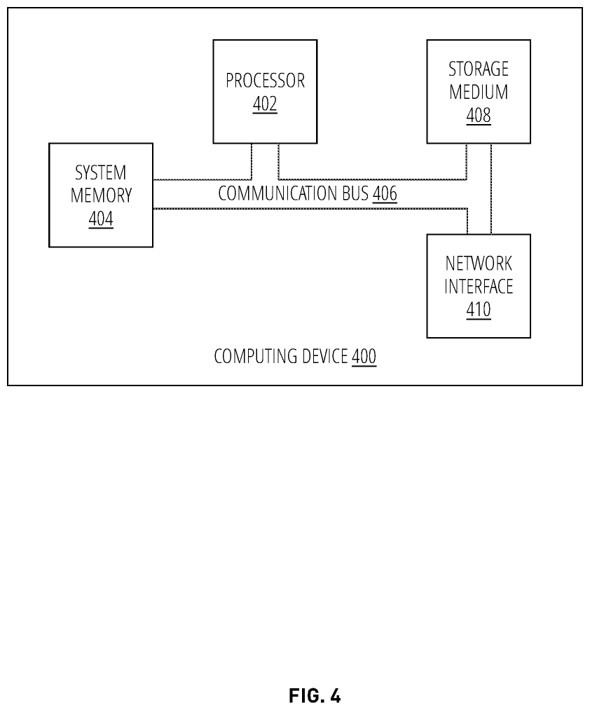

FIG. 4 is a block diagram that illustrates aspects of an exemplary computing device 400 appropriate for use as a computing device of the present disclosure. While multiple different types of computing devices were discussed above, the exemplary computing device 400 describes various elements that are common to many different types of computing devices. While FIG. 4 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 400 may be any one of any number of currently available or yet to be developed devices.

In its most basic configuration, the computing device 400 includes at least one processor 402 and a system memory 404 connected by a communication bus 406. Depending on the exact configuration and type of device, the system memory 404 may be volatile or nonvolatile memory, such as read only memory (“ROM”), random access memory (“RAM”), EEPROM, flash memory, or similar memory technology. Those of ordinary skill in the art and others will recognize that system memory 404 typically stores data and/or program modules that are immediately accessible to and/or currently being operated on by the processor 402. In this regard, the processor 402 may serve as a computational center of the computing device 400 by supporting the execution of instructions.

As further illustrated in FIG. 4, the computing device 400 may include a network interface 410 comprising one or more components for communicating with other devices over a network. Embodiments of the present disclosure may access basic services that utilize the network interface 410 to perform communications using common network protocols. The network interface 410 may also include a wireless network interface configured to communicate via one or more wireless communication protocols, such as WiFi, 2G, 3G, LTE, WiMAX, Bluetooth, Bluetooth low energy, and/or the like. As will be appreciated by one of ordinary skill in the art, the network interface 410 illustrated in FIG. 4 may represent one or more wireless interfaces or physical communication interfaces described and illustrated above with respect to particular components of the computing device 400.

In the exemplary embodiment depicted in FIG. 4, the computing device 400 also includes a storage medium 408. However, services may be accessed using a computing device that does not include means for persisting data to a local storage medium. Therefore, the storage medium 408 depicted in FIG. 4 is represented with a dashed line to indicate that the storage medium 408 is optional. In any event, the storage medium 408 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 404 and storage medium 408 depicted in FIG. 4 are merely examples of computer-readable media.

Suitable implementations of computing devices that include a processor 402, system memory 404, communication bus 406, storage medium 408, and network interface 410 are known and commercially available. For ease of illustration and because it is not important for an understanding of the claimed subject matter, FIG. 4 does not show some of the typical components of many computing devices. In this regard, the computing device 400 may include input devices, such as a keyboard, keypad, mouse, microphone, touch input device, touch screen, tablet, and/or the like. Such input devices may be coupled to the computing device 400 by wired or wireless connections including RF, infrared, serial, parallel, Bluetooth, Bluetooth low energy, USB, or other suitable connections protocols using wireless or physical connections. Similarly, the computing device 400 may also include output devices such as a display, speakers, printer, etc. Since these devices are well known in the art, they are not illustrated or described further herein.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method of generating and providing product recommendations to a subject, the method comprising:
determining, by a computing device, at least one color associated with the subject;
determining, by the computing device, at least one personality trait of the subject;
determining, by the computing device, at least one product recommendation based on at least the at least one color and the at least one personality trait; and
providing the at least one product recommendation to the subject.

2. The method of claim 1, wherein determining the at least one color associated with the subject includes determining at least one of a hair color, an iris color, and a skin color based on at least one image of the subject.

3. The method of claim 1, wherein determining the at least one personality trait of the subject includes:
presenting, by the computing device, a questionnaire to the subject; and
determining, by the computing device, the at least one personality trait based on responses to the questionnaire.

4. The method of claim 3, wherein the at least one personality trait includes at least one of a Myers-Briggs personality type and an Enneagram.

5. The method of claim 3, wherein determining the at least one personality trait of the subject further includes:
determining, by the computing device, an elemental type for the subject based on the responses to the questionnaire; and
validating, by the computing device, the elemental type for the subject based on feedback received from the subject regarding one or more texture samples.

6. The method of claim 1, further comprising generating a beauty identity card that includes the at least one product recommendation.

7. The method of claim 6, wherein the beauty identity card further includes an indication of the at least one personality trait and a color territory.

8. A computing device configured to:
determine at least one color associated with a subject;
determine at least one personality trait of the subject;
determine at least one product recommendation based on at least the at least one color and the at least one personality trait; and
provide the at least one product recommendation to the subject.

9. The computing device of claim 8, wherein determining the at least one color associated with the subject includes determining at least one of a hair color, an iris color, and a skin color.

10. The computing device of claim 9, wherein determining at least one of the hair color, the iris color, and the skin color includes determining at least one of the hair color, the iris color, and the skin color based on at least one image of the subject.

11. The computing device of claim 8, wherein determining the at least one personality trait of the subject includes:
presenting a questionnaire to the subject; and
determining the at least one personality trait based on responses to the questionnaire.

12. The computing device of claim 11, wherein the at least one personality trait includes at least one of a Myers-Briggs personality type and an Enneagram.

13. The computing device of claim 11, wherein determining the at least one personality trait of the subject further includes:
determining an elemental type for the subject based on the responses to the questionnaire; and
validating the elemental type for the subject based on feedback received from the subject regarding one or more texture samples.

14. The computing device of claim 8, wherein the computing device is further configured to generate a beauty identity card that includes the at least one product recommendation.

15. The computing device of claim 14, wherein the beauty identity card further includes an indication of the at least one personality trait and a color territory.

16. A system, comprising:
a color detection engine including computational circuitry configured to:
determine at least one color associated with a subject;
a questionnaire analysis engine including computational circuitry configured to:
determine at least one personality trait of the subject;
a recommendation engine including computational circuitry configured to:
determine at least one product recommendation based on at least the at least one color and the at least one personality trait; and
provide the at least one product recommendation to the subject.

17. The system of claim 16, wherein determining the at least one color associated with the subject includes determining at least one of a hair color, an iris color, and a skin color based on at least one image of the subject.

18. The system of claim 16, wherein determining the at least one personality trait of the subject includes determining the at least one personality trait based on responses to a questionnaire, wherein the at least one personality trait includes at least one of a Myers-Briggs personality type and an Enneagram.

19. The system of claim 16, wherein determining the at least one personality trait of the subject includes:
determining an elemental type for the subject based on the responses to the questionnaire; and
validating the elemental type for the subject based on feedback received from the subject regarding one or more texture samples.

20. The system of claim 16, further comprising a beauty id card generation engine including computational circuitry configured to generate a beauty identity card that includes the at least one product recommendation, an indication of the at least one personality trait, and a color territory.
